(19) United States
(12) Patent Application Publication
(10) Pub. No.: US 2008/0112610 A1
(43) Pub. Date: May 15, 2008

(54) SYSTEM AND METHOD FOR 3D MODEL GENERATION

(75) Inventors: Paul Israelsen, North Logan, UT (US); Robert Pack, Logan, UT (US); Troy Sheen, West Point, UT (US); Dustin Buckthal, Salt Lake City, UT (US)

Correspondence Address: STOEL RIVES LLP - SLC, 201 SOUTH MAIN STREET, ONE UTAH CENTER, SALT LAKE CITY, UT, 84111, US

(73) Assignee: S2, INC., Salt Lake City, UT (US)

(21) Appl. No.: 11/939,663

(22) Filed: Nov. 14, 2007

Related U.S. Application Data
(60) Provisional application No. 60/858,860, filed on Nov. 14, 2006.

(51) Int. Cl. G06K 9/00

(52) U.S. Cl. 382/154

(57) ABSTRACT

A camera including a Lidar and an optical camera captures 3D data representing scans of an object. The Lidar and optical camera may synchronously or asynchronously capture 3D data. An image is generated for each scan. The images are aligned and combined to generate a total image. Alignment of images may be based on received spatial information. The total image is processed to generated a 3D model.

### RELATED APPLICATIONS

This application claims priority to U.S. Provisional Patent Application Ser. No. 60/858,860 filed on Nov. 14, 2006 and entitled “System and Method for Three Dimensional Model Generation,” which is incorporated by reference in its entirety.

### TECHNICAL FIELD

The present invention relates to novel techniques for 3D model generation.

### BRIEF DESCRIPTION OF THE DRAWINGS

Non-limiting and non-exhaustive embodiments of the disclosure are described, including various embodiments of the disclosure, with reference to the following figures:

FIG. 1 is a block diagram of a system for 3D model generation;

FIG. 2 is a flow diagram of a process for generating 3D models in user extensible environments;

FIG. 3 is a flow diagram of a process for generating 3D models for gaming and entertainment environments;

FIG. 4 is a flow diagram of a process for generating 3D models for geo-based on-line e-commerce;

FIG. 5 is a flow diagram of a process for generating 3D models for on-line e-commerce;

FIG. 6 is a block diagram of a system for 3D model generation;

FIG. 7 is a block diagram of an embodiment of a 3D camera; and

FIG. 8 is a block diagram of an embodiment of a 3D camera.

### DETAILED DESCRIPTION OF PREFERRED EMBODIMENTS

The embodiments of the disclosure will be best understood by reference to the figures, wherein like parts are designated by like numerals throughout. It will be readily understood that the methods of the present disclosure, as generally described and illustrated may be embodied in a wide variety of different configurations. Thus the following more detailed description of the embodiments in the Figures is not intended to limit the scope of the disclosure as claimed, but is merely representative of possible embodiments of the disclosure.

In some cases, well-known structures or materials are not shown or described in detail. Furthermore, the described features, structures, or characteristics may be combined in any suitable manner in one or more embodiments. It will also be readily understood that the components of the embodiments as generally described and illustrated in the Figures herein could be arranged and designed in a wide variety of different configurations.

Embodiments may include various steps, which may be embodied in machine-executable instructions to be executed by a general-purpose or special-purpose computer (or other electronic device). Alternatively, the steps may be performed by hardware components that include specific logic for performing the steps or by a combination of hardware, software, and/or firmware.

Embodiments may also be provided as a computer program product including a machine-readable storage medium having stored thereon instructions that may be used to program a computer (or other electronic device) to perform processes described herein. The machine-readable storage medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions.

Suitable networks for configuration and/or use as described here include one or more local area networks, wide area networks, metropolitan area networks, and/or “Internet” or IP networks such as the World Wide Web, a private Internet, a secure Internet, a value-added network, a virtual private network, an extranet, an intranet, or even standalone machines which communicate with other machines by physical transport of media (a so-called “sneakernet”). In particular, a suitable network may be formed from parts or entireties of two or more other networks, including networks using disparate hardware and network communication technologies.

One suitable network includes a server and several clients; other suitable networks may contain other combinations of servers, clients, and/or peer-to-peer nodes, and a given computer may function both as a client and as a server. Each network includes at least two computers such as the server and/or clients. A computer may be a workstation, laptop computer, disconnectable mobile computer, server, mainframe, cluster, so-called “network computer” or “thin client”, personal digital assistant or other hand-held computing device, “smart” consumer electronics device or appliance, or a combination thereof.

The network may include communications or networking software such as the software available from Novell, Microsoft, Artisoft, and other vendors, and may operate using TCP/IP, SPX, IPX, and other protocols over twisted pair, coaxial, or optical fiber cables, telephone lines, satellites, microwave relays, modulated AC power lines, physical media transfer, and/or other data transmission “wires” known to those of skill in the art. The network may encompass smaller networks and/or be connectable to other networks through a gateway or similar mechanism.

Each computer includes at least a processor and a memory; computers may also include various input devices and/or output devices. The processor may include a general purpose device such as a 80.times.86, Pentium (mark of Intel), 680.times.0, or other “off-the-shelf” microprocessor. The processor may include a special purpose processing device such as an ASIC, PAL, PLA, PLD, Field Programmable Gate Array, or other customized or programmable device. The memory may include static RAM, dynamic RAM, flash memory, ROM, CD-ROM, disk, tape, magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The computers may be capable of using a floppy drive, tape drive, optical drive, magneto-optical drive, or other means to read a storage medium. A suitable storage medium includes a magnetic, optical, or other computer-readable storage device having a specific physical configuration. Suitable storage devices include floppy disks, hard disks, tape, CD-ROMs, DVDs, PROMs, random access memory, flash memory, and other computer system storage devices. The physical configuration represents data and instructions which cause the computer system to operate in a specific and predefined manner as described herein.

Suitable software to assist in implementing the invention is readily provided by those of skill in the pertinent art(s) using the teachings presented here and programming languages and tools such as Java, Pascal, C++, C, database languages, APIs, SDKs, assembly, firmware, microcode, and/or other languages and tools. Suitable signal formats may be embodied in analog or digital form, with or without error detection and/or correction bits, packet headers, network addresses in a specific format, and/or other supporting data readily provided by those of skill in the pertinent art(s).

Several aspects of the embodiments described will be illustrated as software modules or components. As used herein, a software module or component may include any type of computer instruction or computer executable code located within a memory device. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Much of the infrastructure that can be used according to the present invention is already available, such as: general purpose computers; computer programming tools and techniques; computer networks and networking technologies; digital storage media; authentication, access control, and other security tools and techniques provided by public keys, encryption, firewalls, and/or other means.

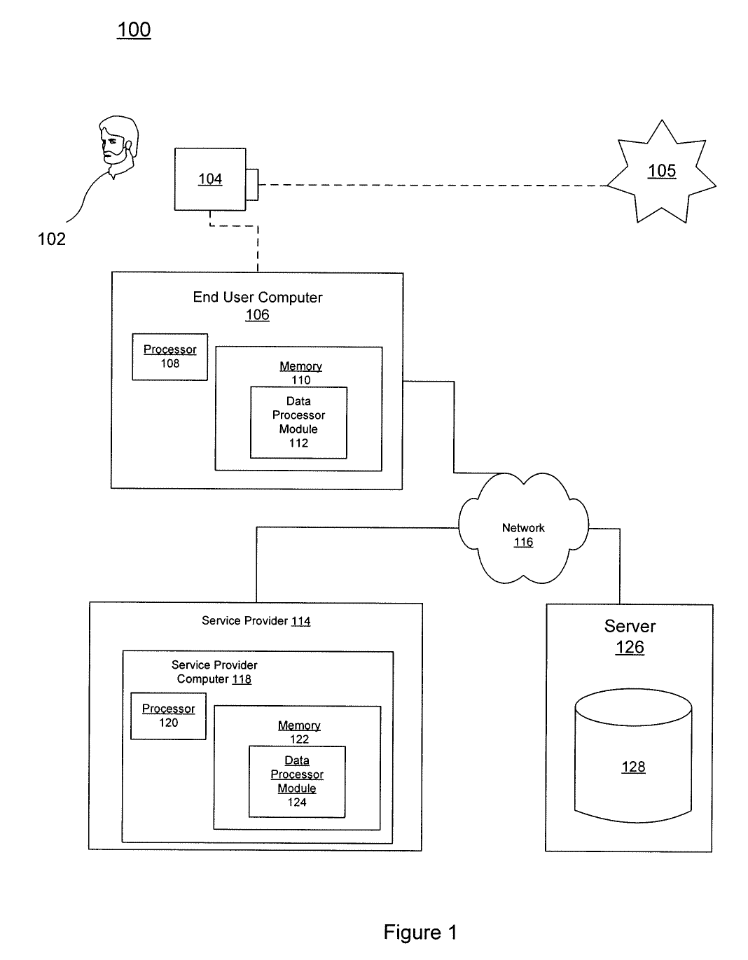

Referring to FIG. 1, a block diagram of a system 100 for capturing 3D data and generating a model is shown. An end user 102 is equipped with a 3D image capture device 104 capable of performing data capture of an object 105 of interest. The object may include, but is not limited to natural features, building structures, commercial products, vegetation, etc. The image capture device 104 may be embodied as a Texel Camera capable of performing the initial 3D data generation. A Texel Camera is one which simultaneously captures a 3D point cloud and the accompanying polygon texture mapping. One description of Texel Cameras is disclosed in U.S. Pat. No. 6,664,529 which is incorporated herein by reference. Cameras used for these applications may include those described in said patent. However, it is also possible and likely to implement Texel Cameras which generate results similar to those discussed in the patent without reliance on the patented technology. Other types of cameras suitable for use with the disclosed methods are known in the art. Cameras used in these described processes may be implemented through a number of different methods. As a primary method of 3D data capture is through the use of various types of Texel Cameras, some examples of Texel Cameras are now discussed.

The image capture device 104 may be embodied as a “flash” type 3D Camera, which captures an entire scene simultaneously rather than sequentially scanning each Texel point one after the other. This technique makes the capture process much faster, and the 3D Camera itself could be manufactured much more inexpensively. Such a 3D Camera may comprise a flash based Lidar which is co-aligned and co-boresighted with an optical camera, such as a CMOS camera, through a cold mirror so that the Lidar and the CMOS camera are viewing the same Region of Interest (ROI) at the same time. Specialized circuitry synchronizes the two cameras to allow data capture simultaneously. A “snapshot” of the camera field of view is captured for all pixels simultaneously. As this type of camera may be made inexpensively, it could drive a rapid market for mass consumer data gathering and end user model generation. This camera may be a hand-held device which the end user 102 carries and capture 3D data. The 3D data is gathered in a free form fashion, meaning that individual pictures would not have to be taken in any special order, or there would be no major constraints on picture location. The end user 102 simply takes care to ensure that the entire scene to be modeled is covered and that there is overlap between the pictures. A data processor is later used to combine these individual pictures into a complete 3D model.

An alternative embodiment for the image capture device 104 is a mobile camera that may be mounted either in an aircraft for aerial collection, or on a mobile land based platform such as a van, golfcart, snowcat, watercraft, etc. This embodiment is likely anticipated for the use of professionals wanting to generate 3D models rather than casual users. A mobile 3D Camera may be a medium range to long range scanning Lidar (10 m to 5000 m) in conjunction with one or more CMOS cameras or possibly a video camera such as a HD studio camera. These CMOS cameras and video cameras are referred to herein as “visual” or “optical” cameras. The Lidar and visual cameras may or may not be co-aligned and co-boresighted through a cold mirror so they are viewing the same ROI at the same time. Specialized circuitry may be responsible for synchronizing the cameras so that they capture data simultaneously. In other cases the various cameras may be allowed to operate asynchronously and time tags or spatial tags on camera data allow the various images to be spatially co-aligned in post processing. This makes it very easy to reconstruct an accurate 3D model of the object or terrain being scanned. The 3D Camera may also incorporate a Global Positioning System (GPS) receiver as well as an Inertial Measurement Unit (IMU). These two pieces of equipment supply information which tell where the 3D camera is located and where it is pointed at all times. Given this information, along with the servo and pointing information from the camera itself, it is possible to locate the geographic location of every Lidar point captured. This in turn makes it possible to geographically reference all the data gathered.

The image capture device 104 may also be embodied as a stationary short to mid-range scanning lidar (1 m to 1000 m) in conjunction with one or more CMOS or video cameras. The Lidar and visual cameras may be co-aligned and co-boresighted through a cold mirror so they are viewing the same ROI at the same time. Specialized circuitry may responsible for synchronizing the cameras so that they capture data simultaneously. In other cases the various cameras may be allowed to operate asynchronously and time tags or spatial tags on camera data allow the various images to be spatially co-aligned in post processing. This makes it very easy to reconstruct an accurate 3D model of the object or terrain being scanned. The 3D Camera may also incorporate a GPS receiver. The GPS supplies information which tells where the Texel Camera is located at all times. Given this information, along with the servo and pointing information from the camera itself, it is possible to locate the geographic location of every Lidar point captured. This in turn makes it possible to geographically reference all the data gathered.

These 3D Cameras are used for gathering 3D data for terrain, environments, movie sets, scenes, studios, building exteriors, building interiors, natural features, small objects, large objects, etc. The 3D Cameras may also be used to gather 3D data for people or animals. All these 3D models could be geo-referenced so that the models can be located and perused by their earth based position. In many applications the geo-reference is not important and can be omitted from the process which makes data collection simpler.

Although reference is made herein to the use of Texel and 3D Cameras, one of skill in the art will appreciate that other image capture devices and methods may be used. By way of example, these may include photogrammetry, traditional Lidar techniques, stereoscopic cameras, satellite imagery, and others known in the art.

After the data capture is completed, the 3D data may be loaded and processed by an end user computer 106. The end user computer 106 includes a processor 108 and a memory 110, such is described above. The memory 110 may include a data processor module 112 to take raw 3D data and manipulate and convert the 3D data to a finished model. The raw 3D data may be expressed as geometries which are converted by the data processor module 112 into true, finished 3D models of environments and objects.

As can be appreciated, the data processor module 112 may need to be operated by an experienced end user 102. Some knowledgeable and experienced end users may wish to use an appropriate data processor module 112 and generate the models themselves. In these cases the end user 102 could buy a software application and run it on the user's own computer. However, it is anticipated that many end users 102 will not have the knowledge or skill necessary to run a data processor module and generate the models themselves. Accordingly, the 3D data may be sent to a service provider 114 which generates a finished model.

The 3D data may be sent to the service provider 114 over a network 116, such as a network discussed above. The 3D data may be sent from the image capture device 104 to the end user computer 106 and then uploaded over the network 116. Alternatively, the image capture device 104 may interface with the network 116 for uploading or even interface directly with the service provider 114. The service provider 114 includes a service provider computer 118 which has a processor 120, memory 122, and a data processor module 124 which takes the raw 3D data and combines it into a complete and useable 3D model. Skilled users employed by the service provider 114 may operate the data processor module 122 to manipulate the 3D data and generate a complete 3D model. The complete 3D model may then be sent back to the end user 102, such as by means of the end user computer 106. An end user 102 is then able to use the completed 3D model as desired. The completed 3D model may be added or integrated into an end user's application on the end user computer 106 and accessed over the network by others.

The service provider 114 may also access a server 126, over a network 116, and upload the 3D model. The server 126 may include a database 128 for online access and storage of 3D models. The server 126 may allow the end user 102 and other users to access one or more 3D models stored in the database 128. Access may be enabled through a user account, subscription, login, and other techniques known in the art. The server 126 may also be configured to enable online viewing of hosted 3D models through suitable software applications. The service provider 114 may also be integrated with the server 126 to provide both image data processing and completed 3D model hosting. Completed 3D models may also be provided to the server 126 from the end user 102, such as through use of the end user computer 106, or through any number of other sources.

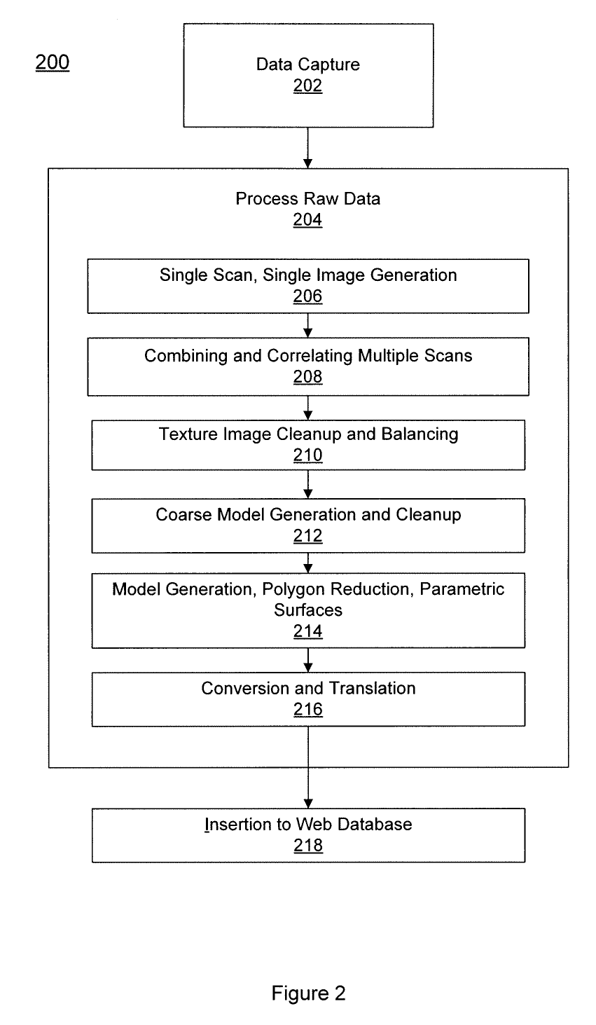

Referring to FIG. 2, a flow diagram for a process 200 for a 3D model generation for extensible applications is shown. An extensible application is one in which the end user or consumer is allowed to modify or add to an existing application. In this process, the end user generates a 3D model of real-world scenes, environments, sets, studios, objects, individuals, etc., and converts these captured objects into one or more 3D models that can be added to an existing application. There are many applications where this could be applicable but two examples are described herein.

The first example is a computer video game. Currently video games are designed to be played in an environment or virtual world. The video game developer manufactures this world using many different techniques. The end user game player can wander in this virtual world to any place the designers have allowed. The idea of an extensible game would be one in which the end user is allowed to modify or extend this virtual world with new environments or objects. This could be done using a CAD or modeling package to generate the extension, but as disclosed herein, the end user uses an image capture device to capture images and data which can be used to build 3D models of real environments and objects. Once these models have been generated the models could be added to the game or the models could be uploaded to an online database where the end user could invite others to share the new environment.

One example would be an end user who takes an image capture device to a high school and captures “images” of the entire school, inside and out. These images are then combined into a complete 3D model of the high school. At this point, the end user could invite friends to incorporate this new model into their games and could continue their gaming experience inside this new environment. As can be imagined the number of gaming environments are endless and personal familiarity with an environment will enhance the gaming appeal.

A second example would be an end user wanting to incorporate some new object or environment into an application such as Google Earth or other GIS package. The end user could take an image capture device and again capture these “images” of the entire house, both inside and out. These “images” could then be combined into a complete 3D model of the end user's house. The complete 3D model could be converted into the proper format used by Google Earth and then uploaded to an online database. Upon creation, the model may be identified by the correct geo-spatial reference information such as latitude and longitude. Any other viewer who happens to be using Google Earth could zoom into the location where the end user's house is located. As a viewer zooms in closer, eventually the new 3D model would be invoked and displayed in a viewer application. At this point the viewer has access to a true, complete 3D model of the house. The viewer could walk around the house, get close to the house, and look at details in full 360 degrees. The viewer may even proceed to the front door and walk into the house. The viewer is able to see all the interior details and walk through the “virtual” house just as if the viewer was there.

There are currently drawing packages which allow a user to draw a crude model of such a house, but this technique enables capture of true-to-life detail and accuracy. In the present application, the final model displayed looks like the actual house. One possible market is the commercial real estate market. Buyers are able to “wander” through a true 3D model of homes that are currently on the market. There are many other applications for the disclosed process beyond those just mentioned.

Step 202 is the raw data capture process which is performed through use of an image capture device capable of recording 3D geometries. Examples of image capture devices are the Texel Camera and 3D Camera described above. After the raw spatial image has been captured, the raw data is processed 204 and combined into a complete and useable 3D model. Step 204 may be performed, in whole or in part, by the data processor module discussed above in operation with a suitable computer. However, certain steps may be performed by an image capture device having a computer. Thus, the raw data may be partially processed before processing by the data processor module. Sophisticated end users may wish to operate the module and generate the complete 3D models themselves. An end user may obtain a software application embodying the data processor module and run it on the user's own computer. However, it is anticipated that many end users will not have the knowledge or skill necessary to run this software application and generate the models themselves.

The end user may upload the raw data to the service manager who has trained employees to operate a data processor module and manipulate the raw data to generate the complete 3D model. The 3D model may then be sent back to the end user for use, or could be uploaded directly to an online database where the end user could access the model and invite others to do the same. Whether the end user or the service provider generates the 3D model, the following steps may be performed.

Processing raw data 204 includes performing a single image generation based on a single scan 206. Once the raw Lidar range data and the visual camera texture information have been captured, the process then “tiles” the visual image data so that the data completes a fully textured piece or slice of the image. These slices are then combined so that spatially the slices generate a complete and seamless textured 3D representation of the scene or model being scanned. The combining of slices may be performed by the image capture device, or could be done by copying the raw data to another computer and doing the processing there. This step has been done on three generations of Texel Cameras previously and is a well known technique within Utah State University. However, the tiling process is slightly different for each camera configuration. At the completion of this step 206 the individual scans exist as a fully textured 3D representation.

The process 200 then combines and correlates multiple scans 208. At this point there are several single scans of an object or environment which may or may not have any spatial correlation between them. These scans may have all been taken with the same image capture device or type of image capture device, or some scans may have been gathered using a completely different type of device from others. Some may have been gathered using traditional techniques, such as photogrammetry or traditional Lidar cameras. These scans can all be correlated using this same process independent of which camera was used. A process of “point cloud matching” is undertaken in order to determine how the individual scans lie in relationship to each other spatially. This point cloud matching can be done manually by a user selecting overlapping points in two adjacent scans, or through a software application, such as a data processor module, which will algorithmically determine the correlating points in adjacent scans and generate the appropriate data to align the images. Essentially a spatial location matrix is generated for each scan which details the scan coordinates in relationship to some origin. One form of this information is contained in a file. Once all the scans have been oriented to the origin of the coordinate system, the data processor module fits the scans together to form a raw full representation of the scanned object or environment.

As 3D models become very large it can be difficult to view and manipulate them. Even very fast computers can become overloaded by complex models. In all these steps where large images and models are being generated, techniques such as Level of Detail (LOD) display and just in time delivery may be used. When viewing and manipulating a 3D model it is only necessary to actually load the polygons into a display processor that can actually be seen. There is no need to load parts of the model that are on the back or sides of the model that are out of view, or to load polygons that are too small to be seen from a given point of view. This is the LOD technique. Just in time delivery states that it is not necessary to deliver polygons for viewing across a network, such as the internet, under these same conditions. Portions of the 3D model are delivered only when they are needed, and once delivered are cached so they don't need to be delivered again. This is very much akin to the approach that Google Earth takes to delivering aerial imagery in the 2.5D environments.

At this stage the geographic location information that may be gathered during the capture process can be attached to the model or models. This means that the exact positioning information on the earth's surface is known. Models can be referenced by that geographic information using any Geographic Information System (GIS) software package, or by any software application that utilizes geographic positioning. Just one example of such software is GoogleEarth.

The process then performs texture image cleanup and balancing 210. In some cases the visual texture data captured by the optical camera may be processed and manipulated to match between scans. In a studio environment where objects are scanned on a rotating platform this is not as critical since lighting can be precisely controlled and constant at all times. However, when scanning outdoors or in changing lighting the visual texture images may have differing intensity levels or color differences as a result of changing lighting. In these cases, it may be desired to manipulate the scan images in order to balance intensity and color so that when the images are “stitched” together into a full model, there aren't visual inconsistencies at the scan boundaries. This cleanup and balancing can be facilitated in traditional off-the-shelf software packages such as Adobe Photoshop, or others. The end result of this step is visual consistency from one image scan to the next.

Next, coarse model generation and cleanup occurs 212. At this stage of the process, the individual scans have been combined into a complete raw 3D model that can be rotated and manipulated at will. Issues arise because the points in the point cloud do not line up exactly from one scan to another. These discontinuities in the point cloud are cleaned up so that edges align and clean polygons can be created between all the points. Special software is used for these tasks. Also, some portions of the model are seen from two or more scans and possibly even from different distances. A determination is made as to which scan should be used for a portion of the model, or as how to combine the results from several scans into a consistent 3D point cloud. In addition, since the point clouds are not precisely aligned, techniques such as “super-resolution” to enhance the resolution of the 3D data beyond the resolution of any of the individual scans may be used.

Another problem arises because some of the polygon faces may overlap from one scan to another. In these cases some decision must be made on which visual data from the various scans should be used to texture those faces. This may be done by selecting the visual data captured from the scan that is most normal to the face, or possibly combining the texture data from multiple scans using Alpha blending or some other filtering technique. The solutions are many and the best solution might be different in different cases. There are a number of other issues that are addressed during this stage. The result at the end of this step is a complete, co-aligned and stitched, visually appealing 3D model of the object or environment.

The process 200 then generates a model and reduces polygons and simplifies parametric surfaces 214. The completed models arising from step 212 may be extremely complex and contain millions or in some cases billions of textured polygons. These huge models may be difficult to view and costly to transmit across the internet. There are many techniques that can be used to reduce the number of polygons and simplify the model. Some examples of software that utilize these techniques are 3D Studio Max, Maya, and SoftImage. Polygon reduction uses a number of techniques to combine and manipulate polygons so that many polygons might be reduced to a few or even one polygon. Surfaces that may be mostly flat might contain many polygons, but could be represented just as well by a single large flat polygon. Parametric surfaces can be used to represent cylinders, spheres, flat areas, and others without huge polygon counts. Displacement maps are a technique which allows models to appear to have high detail without representing all that detail with polygons.

The goal of this process is to greatly reduce the size and complexity of the 3D model while still retaining most of the visual detail. This allows the model to be stored more efficiently, and greatly reduces the time required to transmit and view the model over the internet or some other medium.

The process 200 then converts and translates a 3D model 216. The final 3D model and other objects created by backend tools are converted to some standard format that is used for delivery and viewing. The 3D model may be stored in such a format as to take advantage of LOD and just in time delivery techniques discussed earlier. The conversion formats are determined by the application where the model is to be used and may vary from one application to the next. For example, if the model being generated is to be uploaded to a database for viewing in GoogleEarth, then it will be converted to the KML format which is used by that viewer. In the case of a 3D model being added to a game, the format might be completely proprietary to that individual game. Many other software applications are being used by potential customers and they may require different formats.

At this stage, the 3D model is completed and the model may now be uploaded and inserted into a database 218. As discussed above, the database may be hosted on a server and be accessible over a network, such as the internet. The finished 3D model in the proper format can now be inserted into the application such as a video game, or it can be uploaded to an online database for inclusion and sharing in an online gaming environment or sharing in any other application such as GoogleEarth. In this manner, a user may add to or modify an original 3D model by inserting a newly generated 3D model and thereby create an extended 3D model.

Two applications have been previously mentioned, video games and GoogleEarth or other GIS packages. The number and variety of applications and markets is very large and limited only by the imagination. The key components which enable these applications are: first, an extensible application which allows end users to modify or add data and components; second, specialized image capture devices which allow the gathering of real world “spatial” images; third, a software application which has the capability to take this raw spatial data and manipulate, weed, combine, filter, and process it into a real-world 3D model; and fourth, a service manager, if desired, which can process the data for end users and then deliver the 3D models or directly upload them to online databases.

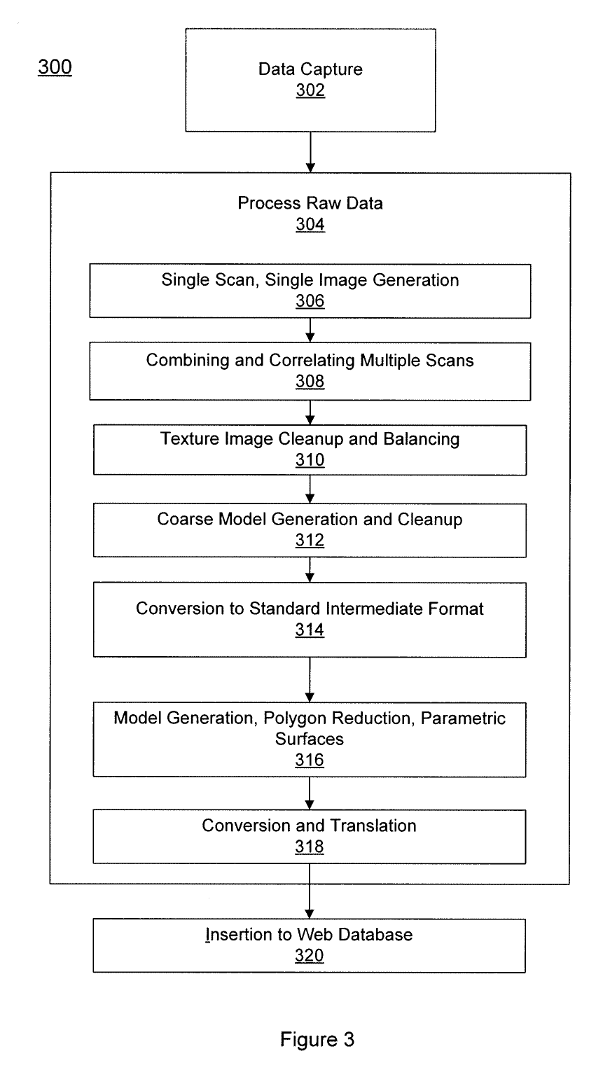

Referring to FIG. 3, a flow diagram of a process 300 specific to 3D model generation and entertainment is shown. In both the gaming and entertainment industries (movies and television) computer graphics are being used to generate objects and environments that simulate the real world. Specialized image capture devices and software applications make it possible to capture real-world scenes, environments, sets, studios, objects, individuals, etc, and convert these captured objects into 3D models that can be used as the starting point for the development of these same objects in the gaming and movie industry. One example would be a video game based on snowboarding. Specialized image capture devices may capture a very accurate and precise model of the Snowbird ski resort in Utah. This model may then be used as the basis for the environment used in the game. The benefits of this approach are that the environments look very much like the real thing, and the process of generating the environment is done much faster and with less expense than current methods.

A second example might be capturing a specific studio set used in the production of a Hollywood film for use as the environment of a game based on a movie.

A third example is the capture of a scene or studio for use in news broadcasts. If a complete 3D model of Times Square is created and stored, any actor, commentator, or object could be placed into that scene at any time in the future for location realistic broadcasts and events. One of skill in the art will appreciate that the applications and examples are very numerous.

The process begins with raw data capture 302 using an image capture devices, such as a Texel Camera or 3D Camera discussed above. The image capture device may be a mobile camera that is mounted either in an aircraft, land craft, or watercraft. The image capture device may include a GPS receiver as well as an IMU. The 3D Camera may be a stationary short to mid-range scanning lidar (1 m to 1000 m) in conjunction with one or more CMOS cameras which has been previously discussed above. Still another camera suitable for use is the “flash” type 3D Camera to capture an entire scene simultaneously rather than scanning a single Texel point one after the other. In addition, other methods could be used such as photogrammetry, traditional Lidar techniques, stereoscopic cameras, satellite imagery, and others.

The process continues with processing the raw data 304. The next steps are single scan, single image generation 306, combining and correlating multiple scans 308, texture image cleanup and balancing 310, and coarse model generation and cleanup 312, which have been discussed above in relation to FIG. 2.

The data is then converted 314 to a standard intermediate format. At this stage of the process the data is ready to be handed off to other software tools or even possibly delivered to customers if the data meets requirements. This delivery or handoff requires some 3D object file format that is acceptable to the parties on each end. A number of different formats could be used. The initial format may be the OBJ file format developed by WaveFront Technologies. Of course, one of skill in the art will appreciate that other formats could be supported as well such as 3D Studio Max (3Dds) files, Maya format, and others. A translation and conversion software module may convert from the internal format to these other standard intermediate formats.

The process then reduces 216 the number of polygons and simplifies the model in a step similar to that discussed above.

The final 3D model and other created objects are converted 218 to a standard format that will be used for delivery and viewing. The conversion formats may be determined with customers, and may be different from one customer to the next. These formats may be determined by the type of software package being used to locate and view the models. For example, a customer may already be using tools to build and develop 3D environments and objects. An example could be SoftImage XSI. In order to use the model which has just been delivered, the object must be in a file format that can be read by the Softimage program. The OBJ format mentioned earlier is one such file format. The customer can import the delivered model into SoftImage and from that point continue to massage, change, add, delete, and improve the model to fit the needs of the intended application. Many other software programs may also be used by potential customers. As can be appreciated, other software packages may require other formats.

The process 300 may include insertion into a web database 320 as previously discussed above.

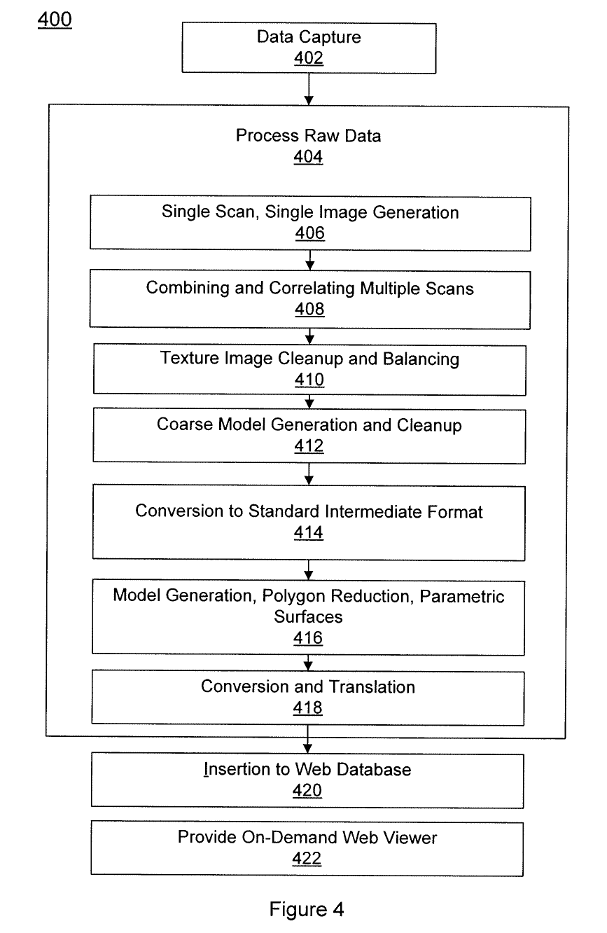

Referring to FIG. 4, a flow diagram for 3D Model Generation for Geo-Based Online E-Commerce is shown. The flow diagram depicts a process 400 that involves the capture of environments and models which can then be tied to their geographic coordinates (latitude, longitude). Some examples would be houses, commercial buildings, recreational sites, stores, etc. This process could be tied closely with the process for small object online e-commerce such as Backcountry.com. For example, a store may be captured, both outside and inside. The store may further be geo-referenced so that users could locate it on mapping software such as GoogleEarth. After locating the store, the user “walks” into the store and browses the 3D models of objects that are for sale in the store.

Another example is the retail housing market. Potential home buyers locate homes on mapping software. The buyers may then view the exterior of the home from an angle and reference point. Essentially users may “walk” around the house and then “walk” through the front door and wander through the 3D model of the house that has been captured from the real house itself. Many other scenarios also exist for this process.

As disclosed herein, an image capture device may be used to generate the 3D data. The resulting 3D model itself may also be the marketable product. The models are generated and sold to fulfill specific needs. In the disclosed process, the 3D models are tools that are used to improve the selection and decision process in buying or marketing other products online. The disclosed process is a unique combination of techniques that are implemented to satisfy a specific market.

The first step 402 is the raw data capture process, similar to those described above. The primary method of 3D data capture may be through the use of various types of Texel Cameras or 3D Cameras such as a mounted mobile camera, a stationary short to mid-range scanning lidar, and a “flash” type Texel Camera. Other methods could be used such as traditional Lidar techniques, stereoscopic cameras, stereoscopic lasers, and others. The process 400 then performs the data processing 404 which may include the following steps: single scan, single image generation 406; combining and correlating multiple scans 408; texture image cleanup and balancing 410; coarse model generation and cleanup 412; conversion to a standard intermediate format 414; simplification and reduction 416; and conversion and translation 418 as previously discussed.

At this stage, a fully finished product is ready for delivery to the customer. The 3D models may now be inserted 420 and incorporated into a web database and into customer web pages so users can download, view and interact with a model. Where the data resides and is served from may change from application to application. For example, in the case of GoogleEarth, the data may reside on servers owned by and located at GoogleEarth sites, or it may reside on the servers of some third party company which receives revenue from the use and viewing of the models.

The process 400 may further provide for an on-demand web viewer 422. An advantageous component of the process 400 is an end user viewer. The 3D model is used as a tool to enable the end user (customer, shopper) to better evaluate the product they are interested in buying. This increases shopper satisfaction with the process and also lessens the possibility of returns due to misinformation. The on-demand web viewer is a software application that allows the shopper to manipulate, view, and evaluate the product. There are several key features that may be incorporated into the viewer.

In this process 400, the viewer may be a plug-in to a standard web browser, but may also be a stand-alone viewer or incorporated into another stand-alone viewer. For example, in the case of GoogleEarth, users download a viewer from Google which allows them to “fly” around the world and locate terrain and objects by their coordinates. When a user locates an object in GoogleEarth which they want to view more closely they will zoom down until the “standard” GoogleEarth view becomes too coarse to provide more information. At this point the 3D model data described in previous sections becomes activated. This may either open a separate viewer to view the new object data, or eventually the standard GoogleEarth viewer might incorporate the necessary additions to allow viewing of the detailed 3D models.

The 3D models which are used contain significantly more data than a traditional 2D object such as a picture. The processes disclosed herein ensure that the end user has a productive and useful viewing experience. Some of these techniques have been mentioned previously such as LOD display and just in time delivery.

The viewer should also be user-friendly to enable easy viewing and manipulation of a 3D model. The viewer may include controls that allow model rotation to any viewpoint and zoom-in capability to allow a user to see detail. This provides the kind of information that cannot be determined from a static 2D picture. There are also tools available such as a measure tool that allows measuring the distance from any point to any other point. For example, a user may measure the distance from one edge of a house to the other, or the size of a refrigerator within that house. The user may also measure the dimensions of a product.

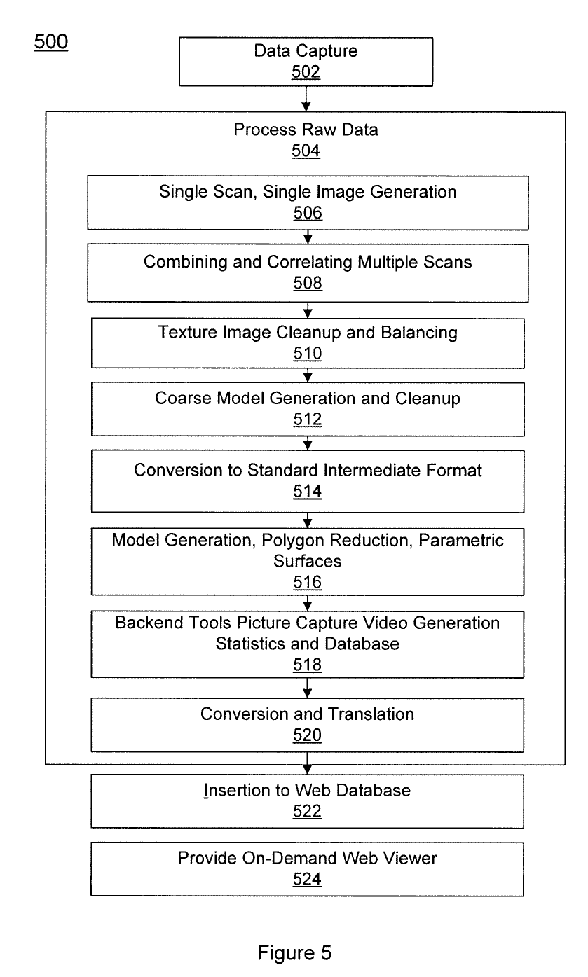

Referring to FIG. 5, a flow diagram is shown for a process 500 for 3D model generation for on-line e-commerce. There is a need to scan relatively small objects to generate 3D models and use these models for viewing in e-commerce. In step 502, data capture occurs by use of an image capture device, such as a Texel Camera or other type of 3D camera. The Texel Camera may be a short to medium range scanning Lidar (1 m to 50 m) in conjunction with a CMOS camera. As explained above, the Lidar and CMOS camera are co-aligned and co-boresighted through a cold mirror so they are viewing the same ROI at the same time. Synchronization circuitry may be used to synchronize the cameras so that the Lidar and CMOS capture data simultaneously. This facilitates reconstruction of an accurate 3D model of the object being scanned.

The disclosed data capture processes may also be implemented using a “flash” type Texel Camera, which captures an entire scene simultaneously rather than scanning a single Texel point one after the other. This technique makes the capture process much faster, and the Texel Camera itself may be manufactured much more cheaply.

The process 500 continues with data processing 504. The single scan, single image generation 506, combining and correlating multiple scans 508, texture image cleanup and balancing 510, coarse model generation and cleanup 512, conversion to standard intermediate format 514, and simplification and reduction 516 are similar to those steps previously described above.

The process 500 may further include use of backend tools for picture capture and video generation 518. Even though the 3D models generated for companies will enhance their marketing efforts, in some cases the companies will still continue to use their current marketing techniques. The current marketing techniques may include 2D images and possibly video segments. Not all customers connect to websites over broadband connections or some may not want to take advantage of the 3D viewing experience. Once a full 3D model is generated of an object or environment, there is no need to go back to current techniques for acquiring those traditional methods. From the 3D model it is possible to capture still images from any angle and size by simply “snapping” a picture from the appropriate perspective. This picture or multiple pictures can be saved as 2D images, such as JPEG images, and used just as in their current marketing flow. In addition some programmed manipulation of the 3D object such as rotation and zooming can be saved as a video segment and used just as any other video segment. These backend tools can be used to generate a number of views and outcomes. The scope of this toolset will certainly grow with interaction with customers and greater understanding of their requirements, and as customers begin to see the power of the 3D model they have available.

The process 500 continues with conversion and translation 520 to a standard format for delivery and viewing. The finished product is then inserted 522 into a web database.

An on-demand web viewer may be provided 524 which is instrumental in enabling the end user to better evaluate the product they are interested in buying. As discussed, the viewer is the software tool that allows the shopper to manipulate, view, and evaluate the product. There are several key features that may be incorporated into the viewer. As there are no existing means of viewing 3D objects in standard web browsers, installation of a third party plug-in to the browser or invocation of a stand-alone viewer is required when the user clicks on a 3D model link. The user may be given the option of viewing the shopping web page in traditional 2D mode, or to see an object in its 3D model mode. If the user chooses the 3D model mode, the end user may required to download and install a web browser plug-in which allows viewing of the model. This plug-in is preferably made small and very easy to install and use. In other cases the 3D viewer may be implemented inside some standard media environment such as Adobe Flash. In this case end users who have Flash installed on their computers would not need to download another application.

The 3D models which are used contain significantly more data than a traditional 2D object such as a picture and employed techniques are to ensure the user has a productive and useful viewing experience. These techniques may include LOD display and just in time delivery. The viewer provides user-friendly viewing and manipulation of a model so that a user has a far greater understanding of how a product appears than from a static 2D picture. Thus, a user may view a product from different sides before deciding whether to purchase the product. The viewer may also have controls for rotation and zooming in and out. The viewer may further provide a measure tool that will allow measuring the distance from any point to any other point. For example, an end user could measure the distance between the mounting screw holes on a ski in order to determine if it is compatible with the user's existing bindings. One of skill in the art will appreciate that other tools may be used to enhance the viewing and decision process.

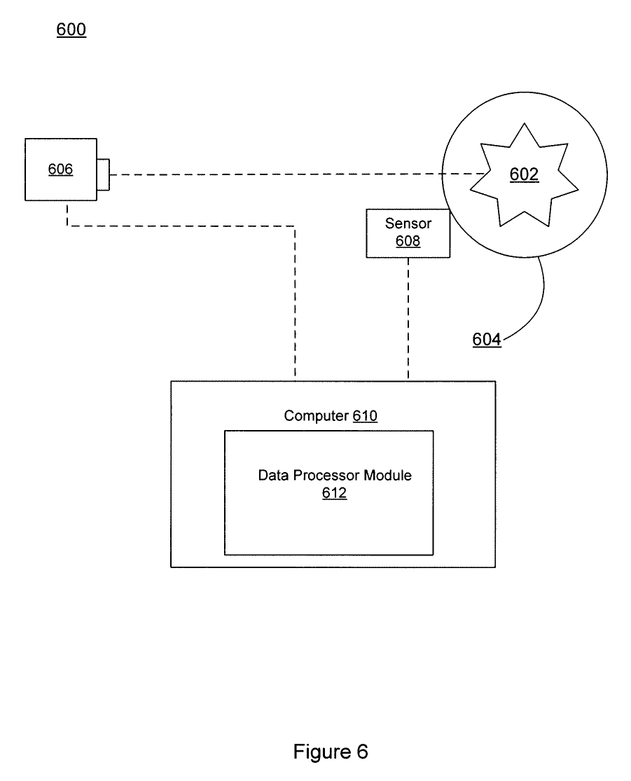

Referring to FIG. 6, a system 600 is shown that captures 3D data of an object. The object 602 to be scanned may be placed on a rotating turntable 604. In one embodiment, a stationary Texel Camera or 3D Cameras 606 may be used and aimed at the center of the object to be scanned. The Camera repeatedly scans a strip or patch from one side to the other of the object 602. As the object 602 is rotated on the turntable 604 through 360 degrees the entire object surface is captured. Although a turntable 604 is referred to herein, another mechanism which rotates an object 602 may be used. The object 602 may then be turned on its side or at an angle and another 360 degree scan is taken. At this point, the entire surface of the object 602 has been scanned and all necessary data has been acquired to generate a complete textured 3D model.

In an alternative embodiment, the object 602 is scanned using a Lidar and then rescanned with a visual camera. Thus, Lidar and visual scanning does not occur simultaneously. The Lidar and visual camera may be separate units or may both be integrated within the 3D Camera 606. A sensor 608 records movement of the turntable 604 and object 602 to provide spatial encoder information. The spatial encoder information may be directly received by the 3D Camera 606 and incorporated into the 3D data. A computer 610 receives the 3D data from the Lidar and visual camera and the spatial encoder information. Alternatively, the computer 610 may receive the spatial encoder information directly from the sensor 608. The computer may include a data processor module 612 which aligns images associated with the Lidar and visual camera based on the spatial encoder information. Furthermore, the computer uses the spatial encoder information to ensure accurate texturing of the images.

In another alternative embodiment, both the Lidar and visual cameras may scan the object 602 simultaneously but asynchronously. The spatial encoder information reflecting movement is then used by a data processor module 612 to align the two images and allow for accurate texturing.

In an alternative embodiment, a unique camera configuration may be used to capture full 360 degree views of interiors and environments. In this technique, a Texel Camera or 3D Camera may be placed on a two axis motion platform. As the 3D Camera is scanning strips or patches, the 3D Camera itself is rotated 360 degrees. This gives a full 360 degree slice of the room or environment. The 3D Camera may then be tilted to another angle and another 360 degree scan is completed. By doing this a number of times a full 360 degree sphere of the environment may be captured. Just as in the previous embodiment, spatial encoder information may be used to co-align the two images.

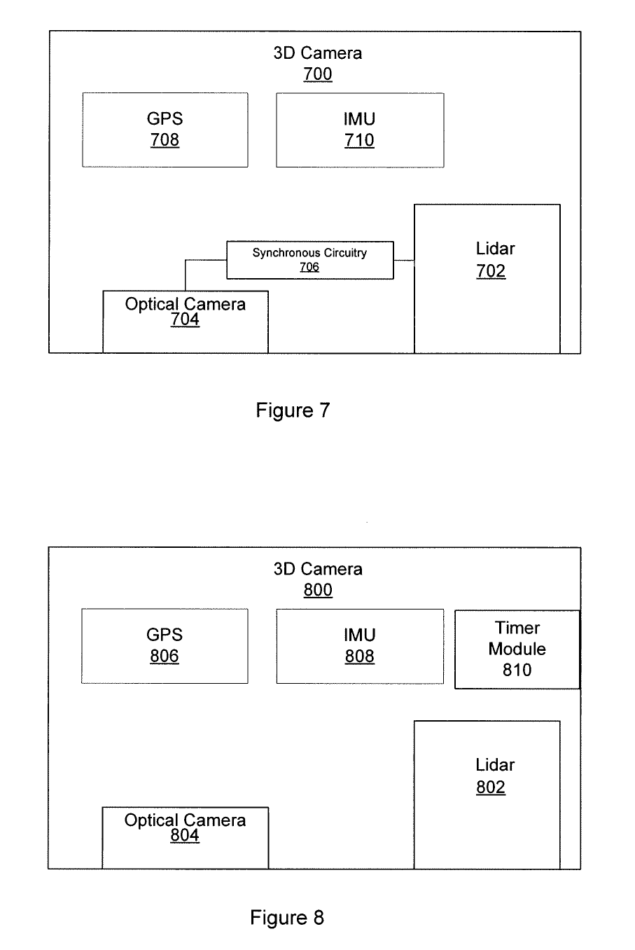

Referring to FIG. 7, an embodiment of a 3D camera 700 is shown that may be used in the embodiments disclosed above. The 3D camera 700 may be embodied as a Texel Camera comprising a Lidar 702 and one or more visual or optical cameras 704. The Texel Camera may be embodied with any of the features disclosed in U.S. Pat. No. 6,664,529. The 3D camera 700 may include synchronous circuitry 706 which causes the Lidar 702 and the visual camera 704 to capture data synchronously. The 3D camera 700 may further include a GPS 708 and an IMU 710 which generate GPS/IMU spatial information. Collectively, the GPS 708 and IMU 710 may be referred to as spatial information generators. At least one of the cameras 702, 704 is configured to receive the spatial information and correlate the information with captured 3D data. As the cameras are synchronized, correlation of one camera and associated 3D data with the spatial information enables correlation of all cameras and associated 3D data. In operation, the 3D camera 700 may be stationary or mounted on a platform or vehicle for mobility. A data processor module, which may be resident in whole or in part on the camera 700 or on a computer, correlates the GPS/IMU spatial information with the 3D data to provide a geographical reference. The geographical reference may be in terms of real world coordinates or any other desired geographical reference, including references invented by the user.

Referring to FIG. 8, an embodiment of a 3D camera 800 is shown that also may be used for the embodiments disclosed above. The 3D camera 800 includes a Lidar 802 and one or more visual or optical cameras 804. The Lidar 802 and visual camera 804 may operate asynchronously and the 3D camera 800 may not include synchronous circuitry. The 3D camera 800 may further include a GPS 806 and an IMU 808 which generate GPS/IMU spatial information. The GPS 806 and IMU 808 may be collectively referred to herein as spatial information generators.

As in the embodiment, of FIG. 7, the 3D camera 800 may be mobile or stationary. As 3D data is generated by each of the cameras 802, 804, a timer module 810 generates time tag information. The time tag information may be inserted into the 3D data generated by the cameras 802, 804. The time tag information may reflect real time. The GPS/IMU spatial information may be stored in association with the time tag information. The time tag information may be used to align scans from the Lidar 802 with scans from the visual camera 804. The time tag information further allows alignment of the scans with the spatial information.

A data processor module, which may operate in whole or in part on the camera 800 or on a separate computer, receives the 3D data with the inserted time tag information. The data processor module further receives the GPS/IMU spatial information. During processing, the data processor module correlates the 3D data of the Lidar with the 3D data of the visual camera to produce one or more images. The data processor module further correlates the 3D data with the GPS/IMU spatial information based on the time tag information. This allows multiple images to be spatially aligned with one another. The data processor module may further use the GPS/IMU spatial information to correlate images in terms of geographical coordinates. The geographical coordinates may be based on real world coordinates or any other coordinates used as a frame of reference.

Thus, in operation a camera 800 mounted on an airplane may capture 3D data of terrain during flight. Time tag information, or other form of time stamp, is inserted into the 3D data and associated with the spatial information. Data processing provides a 3D model with spatially related images and geographical references.

It will be obvious to those having skill in the art that many changes may be made to the details of the above-described embodiments without departing from the underlying principles of the invention.

What is claimed is:

1. A computer-implemented method for generating a 3D model, comprising:
a 3D Camera, comprising a Lidar and an optical camera configured to scan asynchronously, generating 3D data representing multiple scans by the 3D Camera;
generating an image from the 3D data for each of the multiple scans;
receiving spatial encoder information reflecting movement of a scanned object;
aligning images corresponding to 3D data generated by the Lidar and the optical camera based on the spatial encoder information;
combining and correlating the images corresponding to each of the multiple scans to generate a total image;
texturing and cleaning up the total image; and
generating a 3D model based on the total image.

2. The method of claim 1, wherein generating a 3D model includes:
generating a coarse 3D model;
converting the coarse 3D model to a standard intermediate format; and
generating a final 3D model.

3. The method of claim 1, further comprising:
providing a viewer configured to enable a user to view and manipulate the 3D model.

4. The method of claim 3, further comprising:
the viewer generating a viewable still image based on the 3D model.

5. The method of claim 3, further comprising:
the viewer generating a video segment based on the 3D model.

6. The method of claim 3, wherein the viewer further comprises a measure tool configured to provide a distance between two selected points on the 3D model.

7. The method of claim 1, further comprising converting and translating the 3D model into a final format.

8. The method of claim 1, wherein generating a final 3D model based on the coarse 3D model includes reducing polygons and simplifying parametric surfaces.

9. A computer-implemented method for generating a 3D model, comprising:
a 3D Camera, comprising a Lidar and an optical camera configured to scan asynchronously, generating 3D data representing multiple scans by the 3D Camera;
inserting time tag information into the 3D data;
generating an image from the 3D data for each of the multiple scans;
receiving spatial information from a spatial information generator reflecting geographical locations of the 3D camera;
associating time tag information with the spatial information;
spatially aligning the images based on the spatial information and the time tags to generate a total image.

10. The computer-implemented method of claim 9, further comprising:
correlating the total image with the spatial information to provide a geographical reference for the total image.

11. The computer-implemented method of claim 9, further comprising:
generating a coarse 3D model based on the total image; and
generating a final 3D model based on the coarse model;

12. The method of claim 11, further comprising:
providing a viewer configured to enable a user to view and manipulate the final 3D model.

13. A computer-implemented method for generating a 3D model, comprising:
receiving 3D data generated by an image capture device, the 3D data representing multiple scans by the image capture device;
generating an image from the 3D data for each of the multiple scans;
combining and correlating the images corresponding to each of the multiple scans to generate a total image;
texturing and cleaning up the total image;
generating a coarse 3D model based on the total image;
generating a final 3D model based on the coarse model; and
inserting the final 3D model into a database accessible over a computer network; and
modifying an original 3D model stored in the database with the final 3D to create an extended 3D model that is accessible and viewable by users.

14. The method of claim 13, wherein the image capture device comprises a Texel Camera, comprising a Lidar and an optical camera configured to scan synchronously and simultaneously.

15. The method of claim 13, wherein the image capture device comprises a 3D Camera, comprising a Lidar and an optical camera configured to scan asynchronously and wherein the method further comprises:
receiving spatial encoder information reflecting rotational movement of a scanned object; and
aligning images corresponding to 3D data generated by the Lidar and the optical camera based on the spatial encoder information.

16. The method of claim 13, further comprising:
mounting the image capture device on a two-axis motion platform;
the image capture device scanning an interior to generate multiple scans;
receiving spatial encoder information reflecting movement of the image capture device; and
aligning images corresponding to 3D data generated by the image capture device based on the spatial encoder information.

17. The method of claim 13, further comprising converting the coarse 3D model to a standard intermediate format prior to generating a final 3D model.

18. The method of claim 13, further comprising:
providing a viewer configured to enable a user to view and manipulate the final 3D model.

19. The method of claim 18, further comprising:
the viewer generating a viewable still image based on the final 3D model.

20. The method of claim 18, further comprising:
the viewer generating a video segment based on the final 3D model.

21. The method of claim 18, wherein the viewer further comprises a measure tool configured to provide a distance between two selected points on the final 3D model.

22. The method of claim 13, further comprising converting and translating the final 3D model into a final format.

23. The method of claim 13, wherein generating a final 3D model based on the coarse 3D model includes reducing polygons and simplifying parametric surfaces.

24. A computer-implemented method for generating a 3D model, comprising:
mounting an image capture device on a two-axis motion platform;
the image capture device scanning an interior to generate multiple scans;
receiving spatial encoder information reflecting movement of the image capture device;
generating an image from the 3D data for each of the multiple scans;
aligning images corresponding to 3D data generated by the image capture device based on the spatial encoder information;
combining and correlating the images corresponding to each of the multiple scans to generate a total image;
texturing and cleaning up the total image;
generating a coarse 3D model based on the total image; and
generating a final 3D model based on the coarse model.

25. The method of claim 24, further comprising converting the coarse 3D model to a standard intermediate format prior to generating a final 3D model.

26. A computer-implemented method for generating a 3D model, comprising:
receiving 3D data generated by an image capture device, the 3D data representing multiple scans by the image capture device;
generating an image from the 3D data for each of the multiple scans;
combining and correlating the images corresponding to each of the multiple scans to generate a total image;
texturing and cleaning up the total image;
generating a coarse 3D model based on the total image;
generating a final 3D model based on the coarse model; and
providing a viewer configured to enable a user to view and manipulate the final 3D model, the viewer configured to generate a viewable still image based on the final 3D model.

27. The method of claim 26, further comprising:
the viewer generating a video segment based on the final 3D model.

28. The method of claim 26, wherein the viewer further comprises a measure tool configured to provide a distance between two selected points on the final 3D model.

29. A system for generating a 3D model, comprising:
a 3D Camera, comprising a Lidar and an optical camera configured to scan asynchronously, generating 3D data representing multiple scans by the 3D Camera;
a sensor to record spatial encoder information relating to movement of an object to be scanned;
a computer having a processor and a memory to receive the 3D data from the 3D Camera, the memory having a data processor module to perform the method of:
generating an image from the 3D data for each of the multiple scans;
receiving spatial encoder information from the sensor;
aligning images corresponding to 3D data generated by the Lidar and the optical camera based on the spatial encoder information;
combining and correlating the images corresponding to each of the multiple scans to generate a total image;
texturing and cleaning up the total image;
generating a coarse 3D model based on the total image; and
generating a final 3D model based on the coarse model.

30. A method for generating a 3D model, comprising:
a 3D Camera, comprising a Lidar and an optical camera configured to scan synchronously, generating 3D data representing multiple scans by the 3D Camera;
generating an image from the 3D data for each of the multiple scans;
receiving spatial information from a spatial information generator reflecting geographical locations of the 3D camera;
spatially aligning the images based on the spatial information to generate a total image; and
generating a 3D model based on the total image.

31. The method of claim 30, further comprising:
correlating the total image with the spatial information to provide a geographical reference for the 3D model.

32. The method of claim 30, further comprising:
providing a viewer configured to enable a user to view and manipulate the final 3D model.
